(19) United States
(12) Patent Application Publication
(10) Pub. No.: US 2007/0038712 A1
(43) Pub. Date: Feb. 15, 2007

(54) Acquisition of syndication feed items via an information workflow application

(75) Inventors: Michael Anthony Affronti, Seattle, WA (US); Aaron Jady Hartwell, Duvall, WA (US); Ina Teegan, Bellevue, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/204,897

(22) Filed: Aug. 15, 2005

(51) Int. Cl. G06F 15/16

(52) U.S. Cl. 709/206

(57) ABSTRACT

Syndication feed resources, such as those adhering to the Really Simply Syndication (RSS) protocol are accessed, and syndication feed items are acquired from syndication feeds that are available. The syndication feed items are converted to a format compatible with an electronic mail module of an information workflow application so that the converted syndication feed items may be handled by the information workflow application as if they are electronic mail messages. The converted syndicated feed items may be assigned an account within the information workflow application and be synchronized according to the synchronization schedule set forth and may be delivered to the location that is also set forth including a mail folder where electronic mail messages are also placed. Additionally, the converted syndicated feed items may be displayed in a window or preview pane, forwarded, flagged, handled according to user-defined and application-defined mail rules for electronic mail messages, etc.

### BACKGROUND

Syndication feeds such as those provided under the Really Simply Syndication (RSS) 2.0 protocol provide users with new ways of monitoring web-based information sources such as weblogs and general web sites. Such syndication feeds are easily subscribed to and as more syndication feeds become available, users are likely to subscribe to many different feeds. The unfortunate consequence of subscribing to many syndication feeds is that users experience information overload.

Conventionally, users either have a dedicated stand-alone application program for accessing and displaying syndication feed items or have a specific add-in application module that accesses the syndication feed resources and delivers syndication feeds to a syndication feed folder that is accessible via an information workflow application. The dedicated stand-alone application program or syndication feed module extracts each syndication feed item from the syndication feed, which is typically an extensible mark-up language file containing various syndication feed items, and delivers each syndication feed item to a particular location from which it can be displayed. Each item corresponds to an update of the web-based information, such as a new entry in a weblog or a new headline on a website. Accordingly, the user views the syndication feed items within the particular viewing window.

In addition to the syndication feed items, the user likely also has a daily information workflow application for sending and receiving electronic mail messages. Access to the daily information workflow occurs through an application such as OUTLOOK® 2003 information workflow application, from Microsoft Corporation of Redmond, Wash. In many cases as mentioned above, the information workflow application is entirely separate from the stand-alone syndication feed application program that acquires the syndication feeds. Accordingly, in these cases the user is left with utilizing different application programs in order to keep track of the different incoming streams of information, and this burdens the user because it is not a single uniform manner of handling both syndication feed items and electronic mail messages.

Furthermore, even where the syndication feed items are obtained by a syndication feed module that delivers the feed items into folders accessible via the information workflow application, such as in the Outlook Edition from NewsGator Technologies, Inc. of Denver, Colo., the user is still required to interact with the syndication feed module separately from the management module of the information workflow application in order to configure the delivery location and schedule as well as the handling of the syndication feeds. The user is further required to view the syndication feed items by accessing a location where the feed items are delivered that is logically separate from the folder where electronic mail messages are delivered. Thus, the user is still burdened by use of such syndication feed modules that work in conjunction with an information workflow application.

### SUMMARY

Syndication feeds are acquired by an information workflow application that also acquires other information items such as electronic mail messages for the user. Accordingly, the user may be given various benefits of having the syndication feeds acquired in this manner rather than relying on a separate management module or an altogether separate application program. For example, an account manager of the information workflow application may allow the user to configure the acquisition and delivery of syndication feeds in the same manner as creating an account for acquiring and delivery electronic mail messages. As another example, a synchronization manager of the information workflow application may automatically retrieve the syndication feed items on a schedule specified by the user and deliver those feeds to a folder within a message store as also specified by the user. Such account and synchronization management may allow for the user to specify configuration options for the downloading and delivery of the items. Furthermore, user-defined and/or application-defined mail rules may be applied to the syndication items as if they were electronic mail messages and the syndication items may be placed into the same folders as the regular electronic mail message items.

The syndication feed items are first acquired, such as in accordance with user-defined configuration options, and are converted into a format compatible with an electronic mail user interface of the information workflow application. The converted syndication feed items may then be handled as if they were electronic mail messages by displaying them, placing them into folders such as the Inbox or in dedicated folders, and/or by applying at least one of user-defined and application-defined mail rules to further handle the message items as dictated by the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 is an example of a computer system for acquiring syndication feeds using an information workflow application.

FIG. 2A is a diagram illustrating the relationships and sequence of activities of the components of an example of an information workflow application.

FIG. 2B is an example of an operational flow of the information workflow application in relation to the sequence of activities of FIG. 2A.

FIG. 3 is a diagram of one example of the internal component structure of an RSS provider of FIG. 2.

FIG. 4 is an illustrative screenshot showing a dialog box of an account manager of the example of the information workflow application that receives user input to define configuration options for a particular RSS subscription.

FIG. 5 is an illustrative screenshot showing a dialog box of the account manager of the information workflow application that lists the RSS subscriptions of the RSS Subscription account.

FIG. 6 is an illustrative screenshot showing a dialog box of the account manager of the information workflow application for selecting whether to include syndication feed sources in send/receive groups that are utilized by the synchronization manager.

FIG. 7 is an illustrative screenshot showing a rules wizard of the information workflow application to allow the user to define mail rules for automatically processing incoming mail items including electronic mail message items and syndication feed items that are converted to mail items.

FIG. 8 is an illustrative screenshot showing contents of an Inbox folder and a preview pane of the example of an information workflow application where the inbox includes both electronic mail messages and syndication feed items.

### DETAILED DESCRIPTION

Syndication feeds items are obtained and converted to a mail message format by an information workflow application. According to one or more embodiments, the converted syndication feed items are then handled as if they were electronic mail messages within the information workflow application such as by displaying the converted syndication feed items within a window or preview pane and placing the syndication feed item in a particular folder. The syndication feeds may be managed by an account manager of the information workflow application that is also used to manage electronic mail message sources. Synchronization of the syndication feed sources may be handled by a synchronization manager of the information workflow application that is also used to synchronize electronic mail message sources.

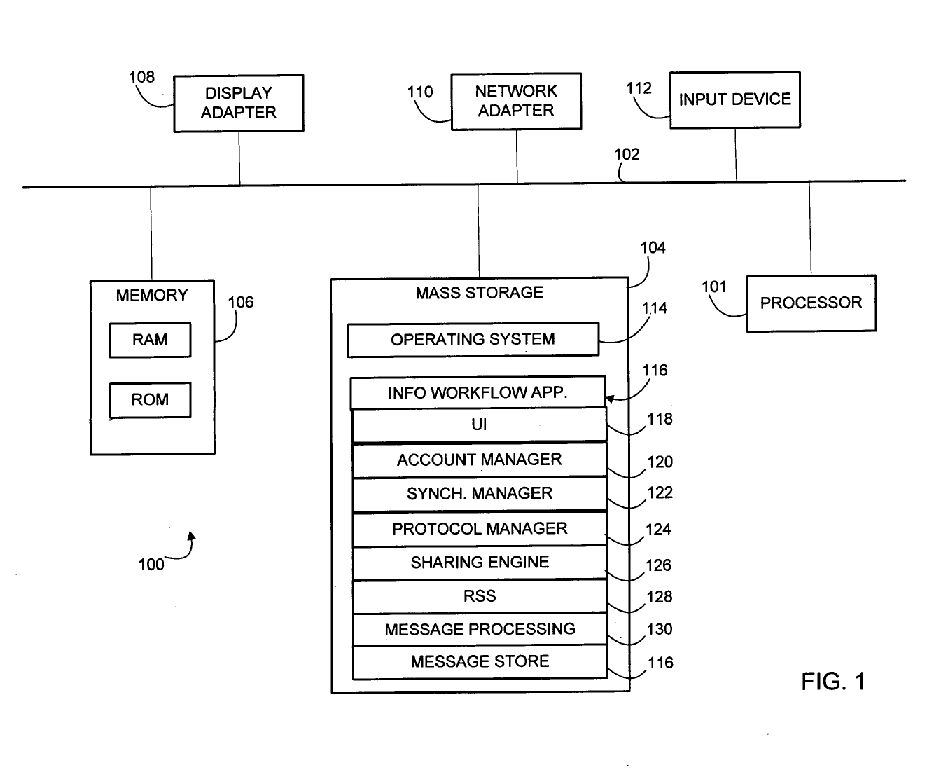

FIG. 1 shows an example of a computer system 100 that provides an operating environment for the embodiments. The computer system 100 as shown may be a standard, general-purpose programmable computer system 100 including a processor 101 as well as various components including mass storage 104, memory 106, a display adapter 108, a network adapter 110 , and one or more input devices 112. The processor 101 communicates with each of the components through a data signaling bus 102. The computer system 100 may alternatively be a hard-wired, application specific device that implements one or more of the embodiments.

In the example, of FIG. 1, the processor 101 implements instructions stored in the mass storage 104 in the form of an operating system 114 and an information workflow application 116, for example, a Messaging Application Programming Interface (MAPI)-compliant application such as an updated version of OUTLOOK® information workflow application from Microsoft Corp. of Redmond, Wash. In doing so, the processor 101 provides data to a display adapter 108 that generated a display on a display screen. The display may include a graphical user interface that allows the user of the computer system 100 to interact with windows and dialog boxes of the graphical user interface when managing electronic mail messages, syndication feed items, and other features provided by the information workflow application program 116. The windows and dialog boxes include controls and data fields that allow the user to make selections when handling electronic mail messages and syndication feed items, and the user makes such selections and enters data through an input device 112, such as a keyboard and/or mouse. Furthermore, the information workflow application 116 makes use of the network adapter 110 to exchange data with remote computer systems, such as electronic mail message servers and syndication feed servers that allow the information workflow application 116 to send and receive electronic information.

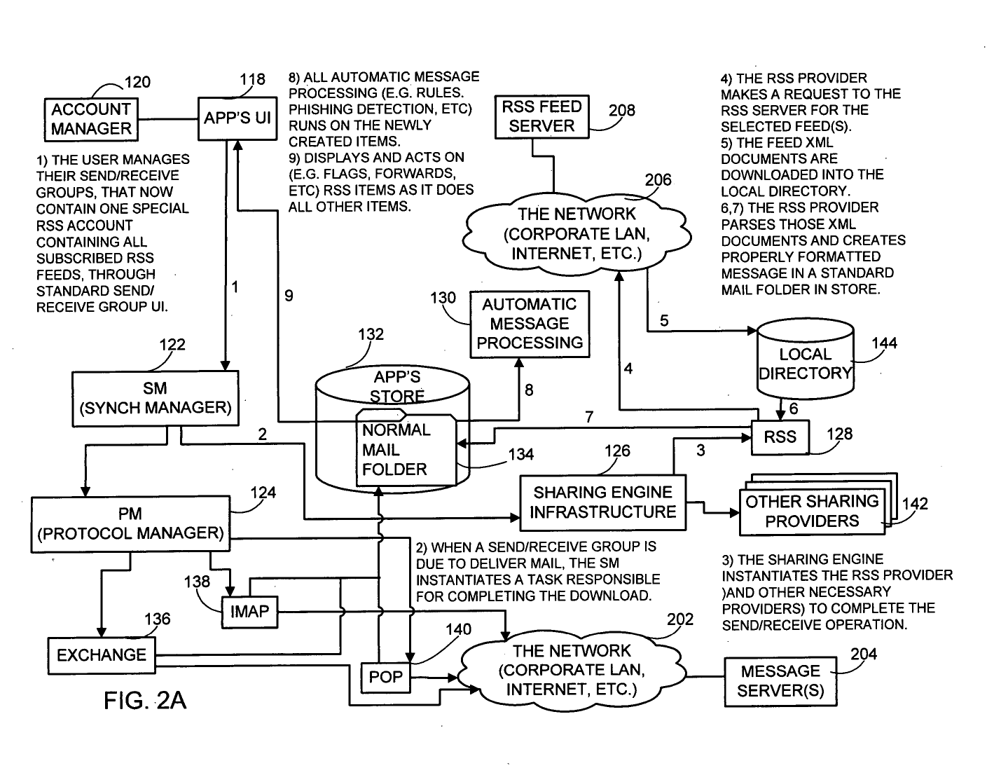

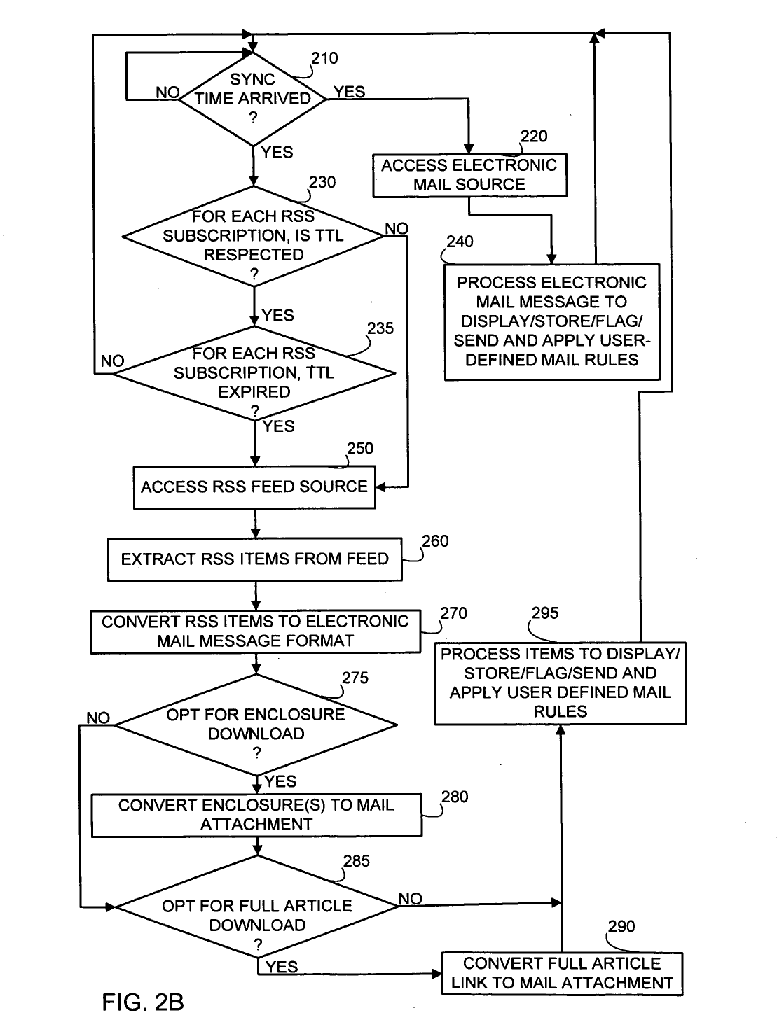

The information workflow application 116 according to the illustrative embodiments discussed herein includes various components as shown in FIG. 1. These components of this example include a user interface 118, an account manager 120, a synchronization manager 122, a protocol manager 124, a sharing engine 126, an RSS provider 128, a message processing component 130, and an electronic mail message store 132. Each of these components is discussed in more detail below with reference to FIGS. 2A and 2B.

Computer system 100 typically includes a variety of computer readable media. Computer readable media can be any available media that can be accessed by computer 100 and includes both volatile and nonvolatile media, removable and non-removable media. By way of example, and not limitation, computer readable media may comprise computer storage media and communication media.

Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer system 100.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

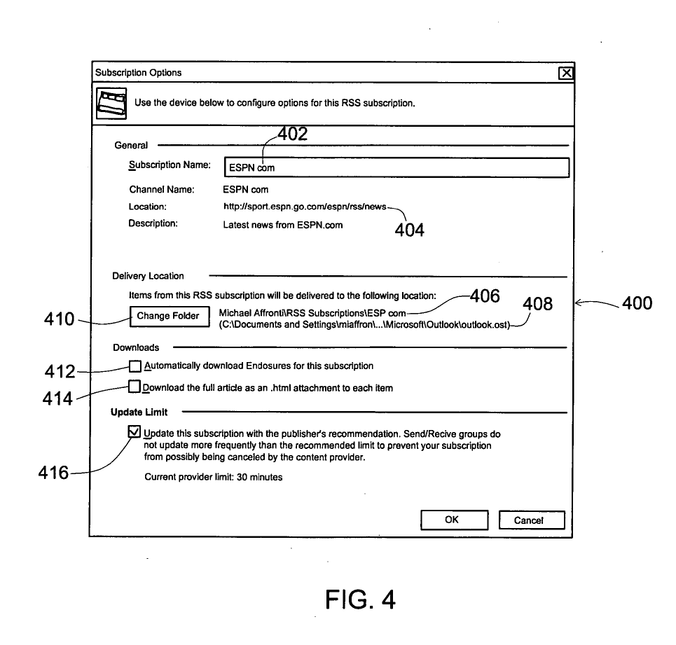

FIG. 2A shows the components of the information workflow application 116 and the sequence of the interactions between them in order to acquire both electronic mail messages and syndication feed items and to place both within a common electronic mail message store. Initially, the user interacts with the account manager 120 via the user interface 118 of the information workflow application 116 in order to configure the information workflow application 116 to provide for the acquisition and automatic updating of the syndication feed items. Examples of this interaction are shown in FIGS. 4-6.

In FIG. 4, a dialog box 400 is displayed via the user interface 118 to allow the user to configure options for a particular RSS subscription. As shown, a field 402 allows the user to provide a name for the subscription. The location such as a universal resource location (URL) 404 has been provided by the user and specifies where the RSS feed of the subscription can be found. A delivery folder name 206 that may be provided as a default and/or may be specified by the user and the message store path 408 where the delivery folder is located is also shown. In this example, the user has chosen a custom folder name and this folder is located within the message store where mail folders are also located. The user can specify that the delivery folder is an existing folder as well, including a folder where electronic mail messages are also delivered such as an Inbox folder. A button 410 provides the user with the option to change the delivery location for the particular RSS subscription.

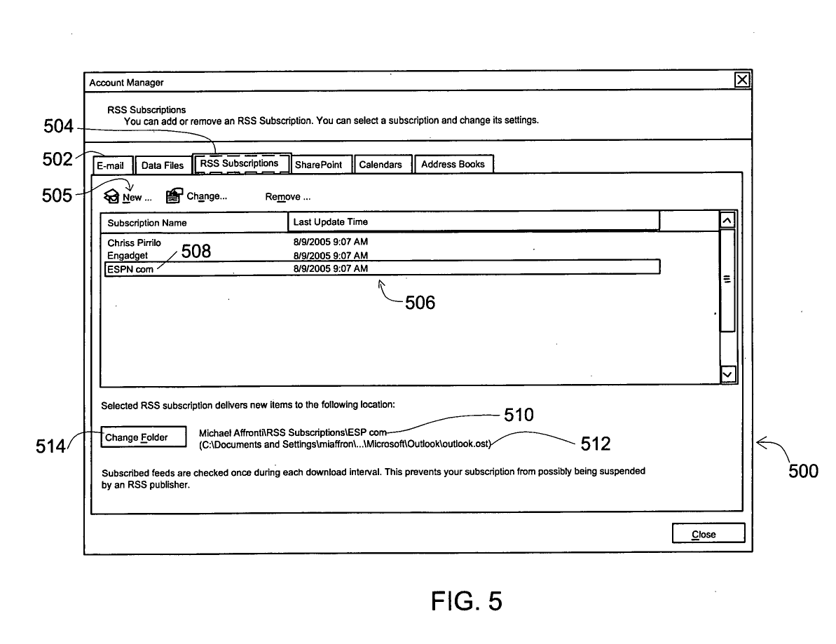

Additional configuration options are also provided in the dialog box 400. Two download options are shown, including an option for selecting to have enclosures of the subscription be automatically downloaded at check box 412. As discussed below, the automatic downloading of enclosures causes them to be converted to mail item attachments for the converted feed item. Another option allows the user to select that the full article be automatically downloaded and converted to an attachment for each syndication feed item at check box 414. The full article to be downloaded may be any electronic document type, such as an hyper text markup language (HTML) document as indicated in FIG. 5, an image file, a text file, etc. The last option pertains to the update limit for the particular subscription. The content provider may set an update interval limit, also known as the time to live (ttl), so that the feed server is not being bombarded with requests, and this update interval may be obtained from the feed itself. If the user opts to use the update limit via check box 416, then the sharing engine does not call upon an RSS provider 128 to access the feed source for the subscription unless the ttl has expired.

In FIG. 5, a dialog box 500 is displayed via the user interface 118 to allow the user to define configuration options regarding syndication feed subscriptions for a syndication feed account. This same account manager 120 also allows the user to set up accounts for acquiring electronic mail messages, so that the user can choose to interact with a single account manager 120 in order to acquire both types of electronic information. The user selects tab 502 to set up one or more accounts for acquiring electronic mail messages and selects tab 504 to set up an account for acquiring syndication feed items.

Each syndication feed subscription to be entered under tab 504 corresponds to a particular syndication feed source. As shown, the user is setting up subscriptions for RSS feeds. However, it will be appreciated that other syndication feeds in addition to RSS feeds may also be included, such as versions of Atom and other feed types. The user begins by selecting the RSS subscriptions tab 504 and then uses toolbar 505 to add new subscriptions or to change or remove existing subscriptions. Selection of toolbar 505 causes the dialog box 400 discussed above to be provided so that the custom configuration options can be set by the user. A table 506 and by then checking each of the desired syndication subscriptions of the listing 508 to “ESPN com” is shown after it has been configured according to FIG. 4. Dialog box 500 also provides the name of the delivery folder 510, the path 512 for the delivery store, and button 514 for allowing the user to change the delivery folder.

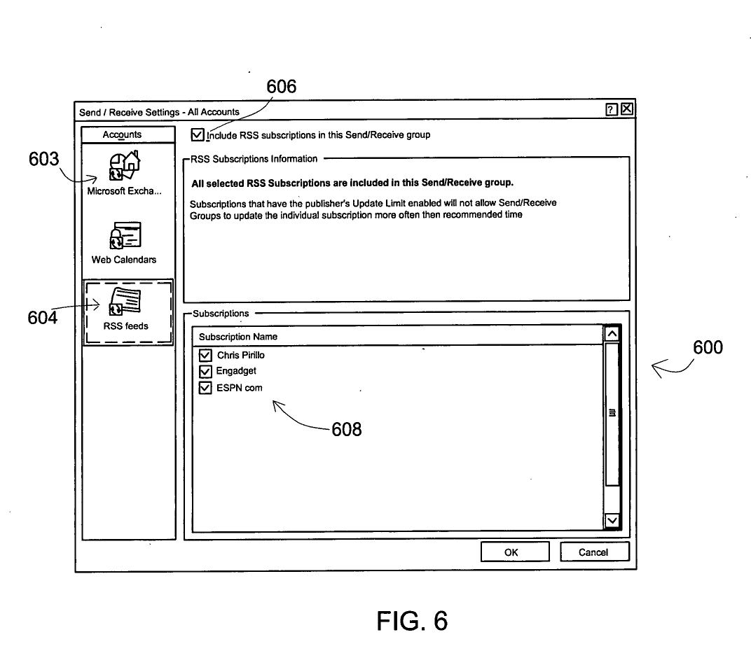

After having added syndication subscriptions, the user may then include the syndication subscriptions in a send/receive group of the information workflow application 116 that is used by the synchronization manager 122 to access the feeds automatically. The send/receive group includes one or more accounts in a group where there is an attempt to send, if appropriate, and receive new messages for all the specified sources of messages. So, as shown in FIG. 6, the user interface 118 may provide a dialog box 600 that allows the user to choose the syndication subscriptions account 604 from a list 602 of accounts. The user may then choose to include syndication subscriptions in the send/receive group by checking the box 606 and by then checking each of the desired syndication subscriptions of the listing 608 that have been previously set up as shown in FIGS. 4 and 5.

Once the user has specified the syndication subscription details including the user-defined configuration options, this information is then made accessible by the synchronization manager 122. The synchronization manager 122 determines whether it is time to synchronize any of the electronic mail message sources or any of the syndication feed subscriptions. This determination may be made for syndication feed subscriptions based solely on the update limit provided by the user or also based on a default update threshold set by the syndication feed itself when it is accessed for the first time. This determination is discussed below with reference to FIG. 2B.

Once the synchronization manager 122 determines that it is time to synchronize an account corresponding to electronic mail messages, the synchronization manager 122 instantiates a task to complete the download of any new electronic mail messages. This task triggers the protocol manager 124 to activate one or more protocols that are available to acquire electronic mail messages. For example, the user may have set up an account 136 that utilizes the Exchange® mail protocol, provided by Microsoft Corp. of Redmond, Wash., an account 138 that uses an Internet Message Application Protocol (IMAP) protocol, and/or an account 140 that uses a Post Office Protocol (POP). The protocol is then utilized to access a message server 204 over a network 202, such as a local area network (LAN) or the Internet.

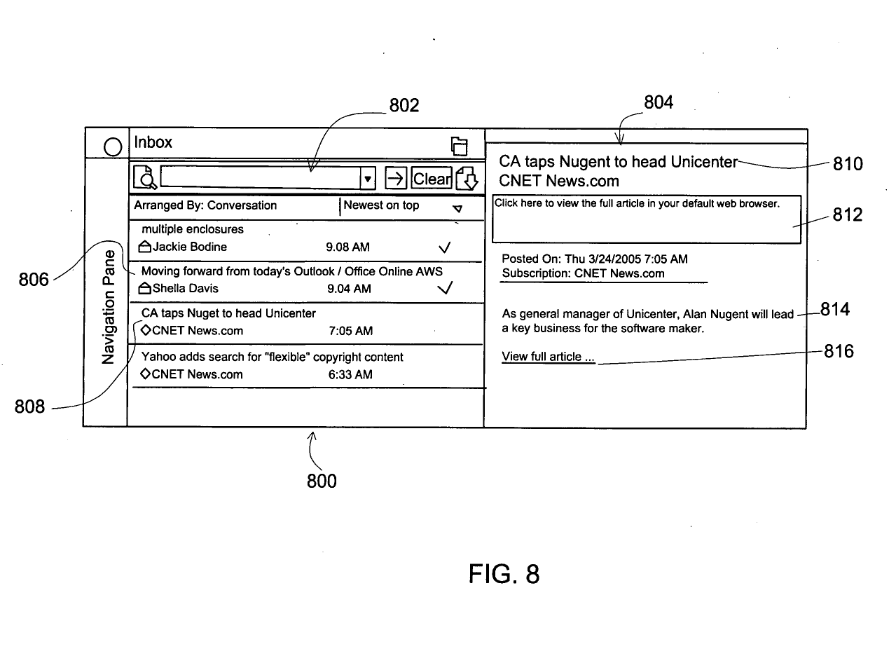

Upon acquiring the new set of electronic mail messages from the message server 204, the protocols 136, 138, 140 submit the electronic mail message to the electronic mail message store 132, and particularly to a mail folder 134 such as the Inbox. Once in the mail folder 134, automatic message processing 130 may be applied to the electronic mail messages, such as applying specific user-defined mail rules for forwarding, deleting, moving, etc., as well as providing any additional automatic processing including application-defined mail rules such as phishing detection The automatic message processing 130 is activated upon the electronic mail messages placed into the mail folder 134 by having a particular flag set for the indicating that the message is subject to the automatic message processing 130. Additionally, the user interface 118 may display the electronic mail messages such as by displaying header information in a folder view and displaying the contents of the electronic mail message in an inspector window or a preview pane. Such display by the user interface 118 is discussed below in relation to FIG. 8.

Once the synchronization manager determines that it is time to synchronize an account that includes syndication feeds and any other sources of information (e.g., WebCals or SharePoint sites), the synchronization manager 122 instantiates a task to complete the download of any new syndication feed items or other information. This task triggers the sharing engine 126 to call upon an RSS Provider 128 for each of the syndication feeds and call upon any other sharing providers 142 that may be necessary for any of the other information sources. Further discussion is limited to the acquisition of the syndication feeds as the other sources of information such as WebCals or SharePoint sites and sharing providers 142 are beyond the scope of this document.

Once called, the RSS Provider 128 submits a request through the network 206, which may be the same network as network 202 or may be different, to syndication feed server 208. The request is for the feeds specified by the user in the account manager 120 as previously discussed. The feed documents, typically in the extensible mark-up language (XML) format, are returned to the RSS Provider 128 where they are stored in a local directory 144, such as one that is specifically for temporary Internet file storage. Syndication feed enclosures may also be obtained via the RSS Provider 128 from the syndication feed server 208.

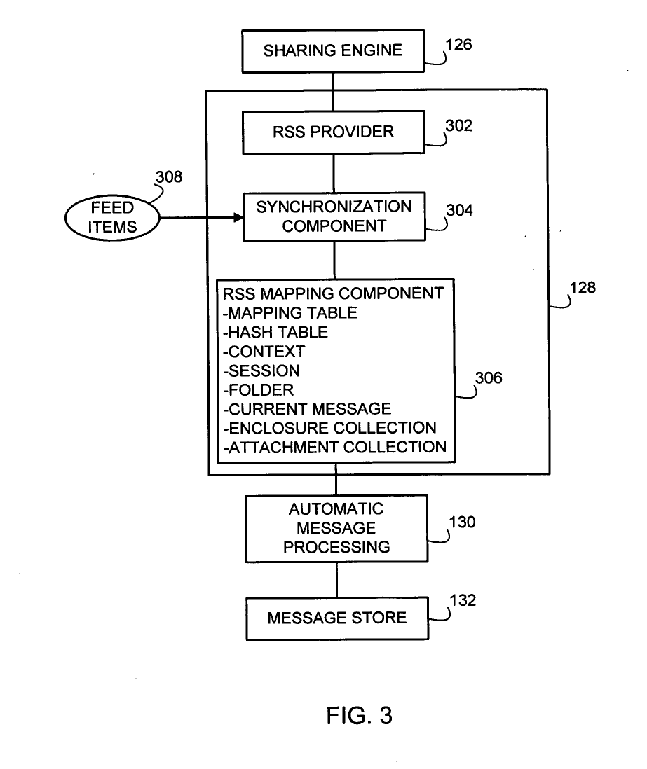

The RSS Provider 128 then processes the documents to produce items to be placed in the message store 132 in the delivery location specified by the user in the account manager 120. The RSS Provider 128 parses the feed documents to find each individual syndication item that may be contained within them, such as by looking for the “item” tags in the document. The RSS Provider 128 converts these syndication feed items that are extracted from the feed documents by applying a mapping of the feed document contents to a format compatible with the user interface 118 of the information workflow application, such as a MAPI-compliant message item. During the conversion, the RSS Provider may also translate the syndication feed enclosures into attachments for the converted syndication feed items and may also download the full article as an attachment if the user has selected either or both of these options. The RSS Provider 128 then places the converted syndication feed items in the designated delivery location, such as the normal mail folder 134, e.g., the Inbox, along with the electronic mail messages that have also been acquired. Details regarding the RSS Provider 128 are discussed below in relation to FIG. 3.

Once the converted syndication feed items have been placed in the mail folder 134 or other location of the electronic mail message store 132, automatic message processing 130 may be applied to the converted syndication feed items. The RSS Provider 128 may be configured to set the special flag that triggers the application of the automatic message processing 130 to each of the converted syndication feed items as if they were regular electronic mail messages, such as by applying specific user-defined mail rules for forwarding, deleting, moving, etc., as well as other automatic message processing including application-defined mail rules such as phishing detection.

Additionally, the user interface 118 may display the converted syndication feed items such as by displaying header information in a folder view and displaying the contents of the converted syndication feed items including any converted attachments in an inspector window or a preview pane. As noted above, such display by the user interface 118 is discussed below in relation to FIG. 8.

FIG. 2B shows an operational flow that may be performed by the information workflow application 116 when employing the synchronization manager 122 and RSS Provider 128 as discussed above. The synchronization manager 122 may implement a query operation 210 to determine whether the synchronization time has arrived for the electronic mail message accounts and the syndication feed account of a particular send/receive group. If the synchronization time has arrived, then the protocol manager dictates that the protocols corresponding to the electronic mail message accounts access the electronic mail message source 204 at mail operation 220. Then the electronic mail messages that are received are processed such as by storing them in the folder 134 or displaying them within the user interface 118 at processing operation 240.

Returning to query operation 210, if the synchronization time has arrived for the send/receive group that includes the syndication feed subscriptions, then the synchronization manager 122 instantiates a task to cause the sharing engine 126 to proceed. The sharing engine then detects whether the ttl is being respected on an individual subscription basis for each of the RSS subscriptions at query operation 320. If not, then the sharing engine 126 proceeds with instantiating the RSS Provider 128 for the particular subscription. The user may have chosen to respect the ttl to ensure that the syndication feed content provider will not temporarily or permanently ban the current user from accessing the syndication feeds, and in that case the sharing engine detects that the ttl value is being respected at query operation 320.

Where the ttl value is being respected, the sharing engine 126 implements query operation 235 to determine whether the ttl value for a given syndication feed has expired since the last time that particular syndication feed was polled. If the ttl value has not expired, then the sharing engine 126 simply does not call upon an RSS Provider 128 for the particular syndication feed for which the ttl value has not expired. However, upon the occurrence of a synchronization time occurring at query operation 210 where the ttl value has expired as found at query operation 235, then operational flow proceeds.

In that case, the sharing engine calls upon the RSS Provider 128 for that particular feed for which the ttl value has expired. The RSS Provider 128 then accesses the syndication feed source at feed operation 250 and extracts the syndication items from the feed at extraction operation 260. The RSS Provider 128 then converts the syndication feed items to the format compatible with the user interface 118 at conversion operation 270, including setting the flag to trigger automatic message processing.

Prior to completing the automatic message processing, a couple of checks may be made by the RSS Provider 128 regarding whether further download processing for the message item is necessary. Query operation 275 detects whether the user has opted to have enclosures be automatically downloaded and if so, then those enclosures are obtained from the source and are converted to attachments to the converted message item at attachment operation 280. Query operation 285 detects whether the user has opted to have the full article be automatically downloaded as an attachment and if so, then the full article is obtained from the source and is included as an attachment to the converted message item at attachment operation 290. Then the converted syndication feed items are automatically processed at processing operation 295, such as by applying the user-defined and/or application-defined mail rules to place the items into the electronic mail message store 132, forward the items, etc. and the items may then be handled by the user via the user interface 118 to have the items displayed, flagged, and so on.

An example of the RSS Provider 128 and its components are shown in more detail in FIG. 3. The components include the RSS Provider component 302 that is called by the sharing engine 126 in order to activate a synchronization component 304 and an RSS Mapping component 306 and provide the data necessary for the particular feed to be accessed and the feed items to be converted. There are 3 sections of sync Meta data relating to each RSS feed.

The first is a SharingRelationshipContext for a feed. Once created, the unique ShareID (GUID) is assigned. The context contains bindings between the remote source path and the local delivery folder that has been specified. The ShareID GUID is used by the Synchronization component 304 to synchronize to the remote RSS feed items 308.

The next is a Hash Value table which is stored in the context for all items in a feed. The associated message stores the binary property which is an array of the hash-values. The properties can be (PR_RSS_HASHTABLE, PT_BINARY), (PR_RSS_HASTABLE_SIZE, PT_LONG).

The third is the Last Sync Time which is also stored in the context for each feed. The synchronization component 304 will record the most recent sync time (FILETIME) whenever a feed is downloaded. The last sync time and sync frequency configuration data of a feed, such as the ttl specified by the feed source, are used to control the feed downloading process.

The information workflow applicatoin may be a read-only syndication feed aggregator so the replication may be in only one direction: download from the remote to local. Synchronization component 304 and RssMapping component 306 work together to download the remote RSS feed content (XML), parsing the XML and mapping it into the electronic mail message item format for storage in the electronic mail message store 132.

According to this embodiment, to prevent duplicate feed items from being stored after each of the synchronization calls, the RSS provider 302 uses the combination of the item's unique GUID, if provided by the content provider, and the hash value based on the item contents to avoid delivering duplicates to the delivery folder. Hash values are calculated for every RSS item that is downloaded. In the case that the RSS item was not assigned a GUID tag value by the content provider, it is instead uniquely identified based only on its hash value. In the case that the content provider did provide a GUID tag value, the RSS item is uniquely identified using that GUID but the hash value is also stored for it so that, if that item is later modified, the original item will be overwritten with the new data (and be marked as unread) rather than discarding the new data due to the perception that the item is a duplicate.

In summary, a feed can be synced in various ways via the RSS Provider 128, including an RSS feed update when a feed is added to the RSS subscription list for the first time, a feed is scheduled to sync by a send/receive group, and a manually forced synchronization such as by hitting F9 or some other hotkey defined as triggering synchronization for the information workflow application 116.

The translation of a syndication feed item to a format compatible with the user interface 118, e.g., an OUTLOOK® post message type, consists of 3 parts: defining the lexical form to follow, i.e., what XML elements to look for and what values to collect, defining an XML parser callback function for an XML parser API to return the parsing result as specified in the RSS Mapping component 306, and defining a syndication feed item format to electronic mail message item type Mapping Table.

The mapping table mechanism of RSS Mapping component 306 provides the maximum flexibility to ensure a schema mapping change can be accomplished by adding/removing the mapping table entry rather than code changes. For each supported RSS item field, there is a mapping entry defined in the table. As one example, the mapping entry structure may be defined as follows:

struct RssMapEntry
{

| | |
|---|---|
| ULONG | ulPropTag; // mapi proptag |
| ULONG | ulType; // type for MAPINAMEID prop |
| MAPINAMEID | propnameid; // nameid prop |
| const WCHAR* | wzRssField; // rss field name |
| ULONG | ulDefault; // default value |
| int | iMaxLen; // max length in wchar, −1 N/A |
| UINT | uiFlags; // flags |

```
  PFNSetProp pfnSetProp;// custom Rss −> Outlook accessor
};
The uiFlags can be defined as:
  RSS_DEFAULT
  RSS_REQUIRED
  RSS_CALCULATED
  RSS_NAMEPROP
```

The iMaxLen is a limit of a user input string length if applied. If parser returns a string longer than the property expects, the string will be chopped at the wz[iMaxLen].

typedef HRESULT (RssAsyncMap::*PFNSetProp) (

LPSPropValue pmval,
ULONG ulPropTag,
WCHAR* pwzValue);

HRESULT RssAsyncMap::SetPropLong(

LPSPropValue pmval,
ULONG ulPropTag,
WCHAR* pwzValue);

HRESULT RssAsyncMap::SetPropGuid(

LPSPropValue pmval,
ULONG ulPropTag,
WCHAR* pwzValue);

HRESULT RssAsyncMap::SetPropFTime(

LPSPropValue pmval,
ULONG ulPropTag,
WCHAR* pwzValue);

HRESULT RssAsyncMap::SetPropWz(

LPSPropValue pmval,
ULONG ulPropTag,
WCHAR* pwzValue);

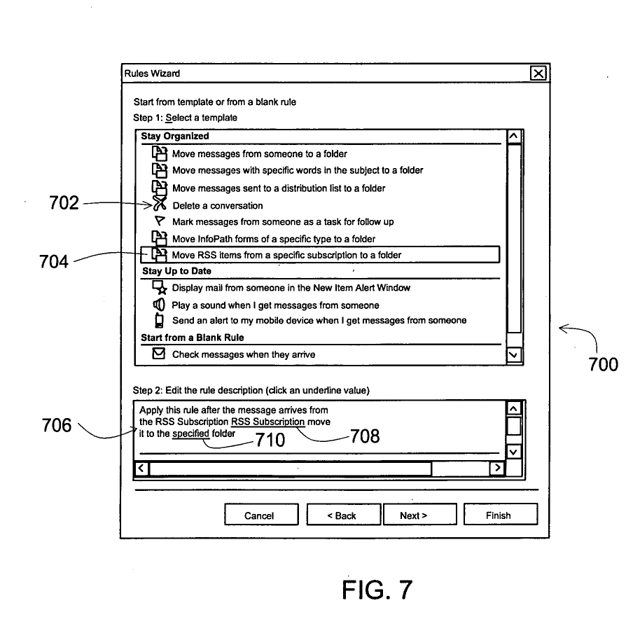

Upon the converted syndication feed item being submitted to the message store 132, the automatic message processing may be applied. The automatic message processing applied to the converted syndication feed items as well as the electronic mail messages may include user-defined mail rules as well as processing that automatically occurs without being defined by the user such as application-defined mail rules. To further illustrate how the user-defined mail rules may be established for application to the converted syndication feed items, FIG. 7 is an illustrative screenshot that includes a dialog box 700 for a rules wizard of the information workflow application 116. The rules wizard provides one example of a listing 702 of actions that the user may select for the rule being created. In this example, the user has selected the option 704 that specifies that RSS items are to be moved from a specific subscription delivery location that has been previously specified by the user-defined configuration options to a particular folder.

The selected rule 706 is shown in a format that allows the user to select the variables for the rule and apply the user-defined values for those variables. The first variable 708 is the particular RSS Subscription that this rule should apply to. By selecting the link of variable 708, the user can specify which RSS Subscription is to be handled according to this rule. The second variable 710 is the particular folder that the RSS items of the particular RSS Subscription should surface within from the message store. By selecting the link of variable 710, the use can specify which folder is to be used.

FIG. 8 shows a screenshot 800 produced by the user interface 118. This particular screenshot 800 shows a listing 800 of message folder contents, and in particular, the contents of the Inbox 802 corresponding to mail folder 134 of FIG. 2A where both electronic mail messages 806 and converted syndication feed items 808 may be stored. Additionally, the screenshot 800 shows a preview pane 804 where message contents are displayed for either electronic mail messages or converted syndication feed items.

As shown, the preview pane 804 is displaying the contents of the converted syndication feed item 808. The preview pane 804 displays the converted syndication feed item 808 as including a title 810, an information bar 812 that may be selected to access the full article, a headline 814 of the article, and a link 816 that also may be selected to access the full article. Thus, as electronic mail messages and converted syndication feed items are acquired and placed together into the Inbox 802, the user can conveniently choose them from the Inbox 802 for display and for performing other tasks such as flagging the message, forwarding the message, deleting the message, etc. regardless of whether the message of the Inbox 802 is an electronic mail message or a converted syndication feed item.

While the invention has been particularly shown and described with reference to various embodiments thereof, it will be understood by those skilled in the art that various other changes in the form and details may be made therein without departing from the spirit and scope of the invention. For example, much of the discussion above has referred to RSS. However, it will be appreciated that the embodiments also apply to other syndication feed protocols including Atom where the parsing and mapping may be specific to the particular protocol being accessed.

What is claimed is:

1. A method of acquiring syndication feeds within an information workflow application, comprising:
utilizing a synchronization manager of the information workflow application to establish a schedule for synchronizing electronic mail messages of remote electronic mail message servers and syndication feed items of remote syndication feed servers with an electronic mail message store of the information workflow application;
when specified by the synchronization schedule of the synchronization manager, accessing by the information workflow application a syndication feed of a remote syndication feed server to obtain a syndication feed item;
converting by the information workflow application the accessed syndication feed item to a format compatible with an electronic mail message user interface of the information workflow application; and
delivering the converted syndication feed item to the electronic mail message store.

2. The method of claim 1, further comprising:
displaying the converted syndication feed item that is placed in the electronic mail message store.

3. The method of claim 2, further comprising:
when specified by the synchronization schedule of the synchronization manager, accessing an electronic mail message source to obtain an electronic mail message; and
processing the electronic mail message to place the electronic mail message within the electronic mail message store.

4. The method of claim 3, further comprising:
receiving user-defined mail rules within the information workflow application for handling electronic mail message items and converted syndication feed items; and
employing automatic processing to apply at least one of the user-defined mail rules and application-defined mail rules within the information workflow application to handle the converted syndication feed items.

5. The method of claim 3, wherein the electronic mail message store includes a mail folder, and wherein the converted syndication feed item and the electronic mail message are placed into the mail folder.

6. The method of claim 1, wherein the syndication feed that includes the syndication feed item is in a really simple syndication (RSS) protocol or an Atom protocol.

7. The method of claim 1, wherein accessing the syndication feed comprises checking a threshold interval for the syndication feed and accessing the syndication feed only if the threshold interval has been exceeded since a preceding access of the syndication feed.

8. The method of claim 1, wherein the format compatible with the electronic mail message user interface is a MAPI message type.

9. The method of claim 1, wherein converting the syndication feed item comprises:
determining whether an option has been set for downloading of enclosures and if so then converting an enclosure of the syndication feed item to an attachment within the converted syndication feed item; and
determining whether an option has been set for downloading of full articles and if so then downloading a full article associated with the syndication feed item and including the full article as an attachment within the converted syndication feed item.

10. A computer readable medium having computer-executable instructions encoded thereon for performing steps comprising:
providing an information workflow application having an account manager for establishing an electronic mail message account and a syndication feed account, the syndication feed account specifying a set of syndication feeds and a delivery location for each syndication feed where the delivery location is within an electronic mail message store of the information workflow application;
in accordance with the syndication feed account, accessing each syndication feed to obtain syndication feed items for each syndication feed;
converting the syndication feed items into a format that is compatible with an electronic mail message user interface of the information workflow application;
delivering the syndication feed item to the delivery location of the electronic mail message store of the information workflow application in accordance with the syndication feed account; and
displaying the syndication feed item within the electronic mail message user interface of the information workflow application

11. The computer readable medium of claim 10, wherein the computer executable instructions are for performing additional steps comprising:
in accordance with the electronic mail message account, accessing an electronic mail message source associated with the electronic mail message account to obtain an electronic mail message;
in accordance with the electronic mail message account, placing the electronic mail message in the electronic mail message store of the information workflow application; and
displaying the electronic mail message within the electronic mail message user interface of the information workflow application.

12. The computer readable medium of claim 11, wherein the electronic mail message store comprises a mail folder, wherein processing the converted syndication feed item comprises placing the converted syndication feed item in the mail folder, and wherein processing the electronic mail message comprises placing the electronic mail message in the mail folder.

13. The computer readable medium of claim 12, wherein the syndication feed item is in a really simply syndication (RSS) protocol or an Atom protocol.

14. The computer readable medium of claim 13, wherein the format that is compatible with the electronic mail message user interface comprises a messaging application programming interface (MAPI) message type.

15. The computer readable medium of claim 14, wherein the information workflow application further includes a synchronization manager, wherein the syndication feed account further specifies an update setting for each syndication feed, and wherein the synchronization manager synchronizes the electronic mail message store with the syndication feed resources in accordance with the update setting for each syndication feed.

16. A computer system comprising:
a display;
a network connection;
a storage device that is organized into a plurality of logical portions, one of the logical portions comprising an electronic mail message store;
a processor executing instructions to instantiate an information workflow application that includes an electronic mail message user interface, wherein the information workflow application instantiates tasks to access a syndication feed source through the network connection to obtain a syndication feed item, access an electronic mail message source to obtain an electronic mail message, convert the syndication feed item into a format that is compatible with the electronic mail message user interface, and deliver the converted syndication feed item and the electronic mail message to an electronic mail message store.

17. The computer system of claim 16, wherein the message store includes a mail folder and wherein the converted syndication feed item and the electronic mail message are delivered into the mail folder.

18. The computer system of claim 16, wherein the information workflow application includes a synchronization manager that performs synchronization to periodically and without user intervention check the syndication feed source and the electronic mail message source for new syndication feed items and new electronic mail messages.

19. The computer system of claim 18, wherein the information workflow application includes an account manager, wherein the account manager includes an account for syndication feeds where the account specifies a user-defined delivery location for each syndication feed that is within the electronic mail message store and specifies a user-defined synchronization period, and wherein the synchronization manager utilizes the synchronization period for checking the electronic mail message source only if a default synchronization threshold has been exceeded since the last attempt at synchronization with the syndication feed source.

20. The computer system of claim 19, wherein the syndication feed source is in the really simple syndication (RSS) protocol or an Atom protocol.
